(19) United States
(12) Patent Application Publication
(10) Pub. No.: US 2015/0227397 A1
(43) Pub. Date: Aug. 13, 2015

(54) ENERGY EFFICIENT ASSIGNMENT OF WORKLOADS IN A DATACENTER

(71) Applicant: CA, Inc., Islandia, NY (US)

(72) Inventors: Rajasekhar Gogula, Hyderabad (IN); Serguei Mankovskii, San Ramon, CA (US); Douglas Neuse, Austin, TX (US); Ramanjaneyulu Malisetti, Hyderabad (IN); Subhasis Khatua, Hyderabad (IN)

(73) Assignee: CA, Inc., Islandia, NY (US)

(21) Appl. No.: 14/176,948

(22) Filed: Feb. 10, 2014

(51) Int. Cl. G06F 9/50; G06N 99/00

(52) U.S. Cl. CPC G06F 9/5094; G06N 99/005

(57) ABSTRACT

A computing workload is allocated amongst servers based on energy usage considerations. An energy consumption model is created for different server configurations. Based on the energy consumption models for the respective server configurations, different energy consumptions are predicted for executing a workload in corresponding different allocations of the workload on the servers. One of the allocations is selected based on the predicted energy consumptions. The selected allocation could minimize total energy use, reduce peak energy use, spread out energy use, etc.

### BACKGROUND

The present disclosure relates to computer systems, methods and computer program products for energy efficient assignment of workloads to computer servers.

A data center is a facility used to house computer systems and associated components. Data centers are proliferating across the world with the increase in use of technology, such as the Internet, virtualization and cloud computing. A data center can provide advantages, such as hosting large numbers of computers, commonly referred to as “servers”, in a small space, which can also provide simplified cabling, a controlled environment (such as air conditioning and fire suppression), redundant or backup power supplies and security. Large data centers are industrial operations that can consume as much electricity as a small town. The primary influencer of this power consumption generally is the server. Thus, as server volumes grow, the overall power consumption of the data center may also continue to grow.

A data center may house many different types of servers, from different manufacturers, using different generations of technology and/or having different capabilities.

### BRIEF SUMMARY

According to one aspect of the present disclosure a computing workload is allocated amongst servers based on energy usage considerations. One embodiment includes a method comprising the following. An energy consumption model is created for different servers. Based on the energy consumption models for the respective servers, different energy consumptions are predicted for executing a workload in corresponding different allocations of the workload to the servers. An allocation of the workload to the servers is selected based on the predicted energy consumptions.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

The accompanying drawings, which are included to provide a further understanding of the present disclosure and are incorporated in and constitute a part of this application, illustrate certain embodiment(s). In the drawings:

FIG. 1 is a simplified block diagram of a conventional data center.

FIG. 2 is a simplified block diagram of a conventional server in a conventional data center of FIG. 1.

FIG. 3 is a simplified block diagram of a conventional Central Processing Unit (CPU) of a server of FIG. 2.

FIG. 4 is a simplified block diagram of a data center including a data center management system, method and computer program product according to various embodiments described herein.

FIG. 5 is a block diagram of a data center management system, method and computer program product according to various embodiments described herein.

FIGS. 6-8 are flowcharts of operations that may be performed by a power usage index system, method and/or computer program product according to various embodiments described herein.

FIG. 9 graphically illustrates a prediction of energy usage according to various embodiments described herein.

FIG. 10 is a block diagram of a data center management system, method and computer program product according to various other embodiments described herein.

FIG. 11 is a flowchart of operations that may be performed by a non-data processing overhead system, method and computer program product according to various embodiments described herein.

FIGS. 12 and 13 are flowcharts of operations that may be performed to selectively assign future workload according to various embodiments described herein.

FIG. 14 is a diagram of a system that determines how to place workloads on servers based on energy considerations, in accordance with embodiments.

FIG. 15 is a flowchart of one embodiment of a process of allocating a workload to servers based on energy considerations.

FIG. 16 is a flowchart of one embodiment of a process of creating a library of energy consumption models.

FIG. 17 is a flowchart of one embodiment of a process of allocating a workload to servers based on energy considerations.

FIG. 18 is a flowchart of one embodiment of a process of predicting energy consumption for a specific allocation of the workload to servers.

### DETAILED DESCRIPTION

As was noted above, data center power consumption is often at an industrial scale and some data centers may consume as much electricity as a small town. Yet, heretofore, mechanisms do not appear to have been available to provide a reliable estimate of energy that may be consumed by a server for a given workload. Various metrics may exist that can provide a normalized unit of computing demand that is placed on an Information Technology (IT) infrastructure in a data center. This metric may be thought of as being similar to Millions of Instructions Per Second (MIPS) in mainframe technology. One such metric is referred to as Total Processing Power (TPP) that was developed by Hyperformix, Inc., and is now embodied, for example, in the computer programs “CA Capacity Manager” and “CA Virtual Placement Manager”, both of which are marketed by CA, Inc.

According to various embodiments described herein, a power usage index, also referred to as a “Portable Energy Consumption” (PEC) metric, is provided that defines an amount of power that is consumed by a server for a unit of workload performed by the server. For example, in some embodiments, if a unit of workload is measured in “TPP”, then the power usage index can provide a “Watt/TPP” metric that enables estimation of the energy that will be used for processing one TPP of demand. Future power usage by the server may then be predicted based on the power usage index and a projected workload demand on the server. Knowledge of the total TPP demand on the server, for example for the next hour, can predict future power usage in terms of “Watts per hour”. By determining energy demand per unit of normalized computing demand, future power usage by a server may be predicted, and workload may be assigned in response to the prediction. The power usage index may provide a normalized metric, so that the power usage index may provide a reliable estimate of the energy use across many servers from many manufacturers having different configurations and/or capacities. Existing energy management metrics do not appear to be normalized, so that it is difficult to use these energy management metrics across the wide variety of servers that are used in a data center. It will be understood that energy usage may be used to derive power usage (e.g., Watts and/or Joules/sec), and power usage may be used to derive energy usage (e.g., Joules and/or kWhr).

According to various other embodiments described herein, non-data processing overhead, also referred to as “non-IT overhead” may be taken into account in allocating future workload among a plurality of data centers, aisles in a data center, racks in a data center and/or servers in a rack of a data center, in addition to considering power that is consumed by a server, rack, aisle and/or data center to perform a data processing workload, also referred to as “IT overhead”. An ability to predict total IT and non-IT energy use of a future workload can open up opportunities for reducing, and in some embodiments minimizing, total energy demand by placing workload in different data centers and/or in different parts of a data center, in terms of space and/or time. Placing workload in terms of space can allow various embodiments described herein to find a physical server, rack, aisle and/or data center in such a way that the total energy expenditure may be reduced or minimized. Placing workload in terms of time may allow a time interval to be found when execution of a future workload would reduce or minimize the total energy expenditure for performing the workload.

According to various other embodiments described herein a workload is allocated to servers based on energy considerations. For example, the system can determine how the workload over the next 24 hours should be allocated to different servers. This can be used to minimize total energy consumption for performing the workload, or some other energy considerations. For example, the peak energy consumption could be reduced or kept below some target level. A similar example is to shift energy consumption to a different period. For example, it might be desirable to reduce energy consumption during a certain time of day. Many other energy considerations can be factored in.

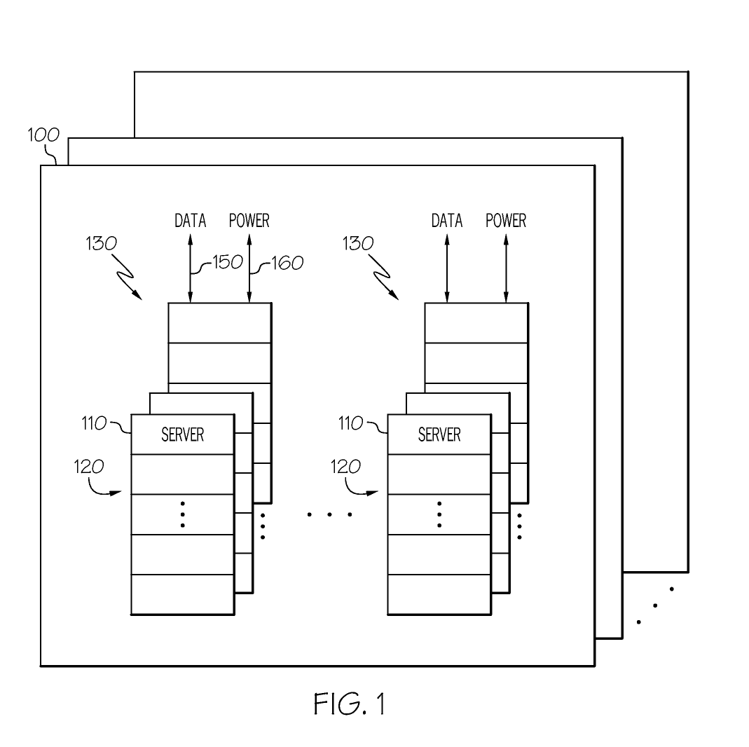

FIG. 1 is a simplified block diagram of a conventional data center 100. As shown in FIG. 1, the data center 100 includes a plurality a servers 110 that may be configured in racks 120. The racks may be configured along aisles 130. Data input/output connections 150 are provided, and power connections 160 are also provided to the servers 110. A given enterprise may operate multiple data centers 100, as illustrated in FIG. 1.

It will be understood that the simplified block diagram of FIG. 1 does not illustrate many other systems of the data center 100 including, for example, environmental systems such as air conditioning systems, power and backup power systems, cable routing systems, fire protection systems and security systems. It will also be understood that a respective server 110 may be embodied as one or more enterprise, application, personal, pervasive and/or embedded computer systems that are operable to receive, transmit, process and store data using any suitable combination of software, firmware and/or hardware and that may be standalone or interconnected by any conventional, public and/or private, real and/or virtual, wired and/or wireless network including all or a portion of the global communication network known as the Internet, and may include various types of tangible, non-transitory computer readable medium.

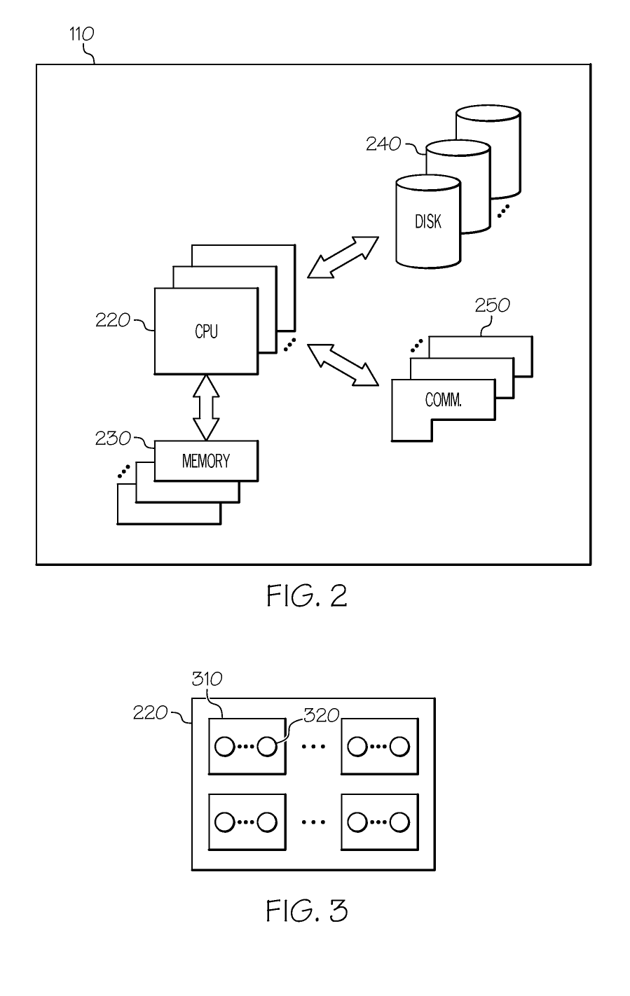

FIG. 2 is a simplified block diagram of a conventional server 110 of FIG. 1. As shown, the server may include a processor subsystem 220, including one or more Central Processing Units (CPU) on which one or more operating systems and one or more applications run. A memory subsystem 230 may include a hierarchy of memory devices such as Random Access Memory (RAM), Read-Only Memory (ROM), Erasable Programmable Read-Only Memory (EPROM) or flash memory, and/or any other solid state memory devices. The storage (disk drive and network store) subsystem 240 may also be provided, which may include a portable computer diskette, a hard disk, a portable Compact Disk Read-Only Memory (CDROM), an optical storage device, a magnetic storage device and/or any other kind of disk- or tape-based storage subsystem. Finally, a network communications subsystem 250 may provide bidirectional communications within the data center and/or external to the data center, for example using the Internet and/or dedicated lines.

FIG. 3 is a simplified block diagram of one of the processor subsystems 220 of FIG. 2. As shown in FIG. 3, a processor subsystem 220 may include a plurality of microprocessor cores 310, each of which may include, for example, its own floating point unit and its own instruction pipeline. Within the microprocessor cores 310 it is possible to fork the instruction pipeline into multiple logical processor threads 320.

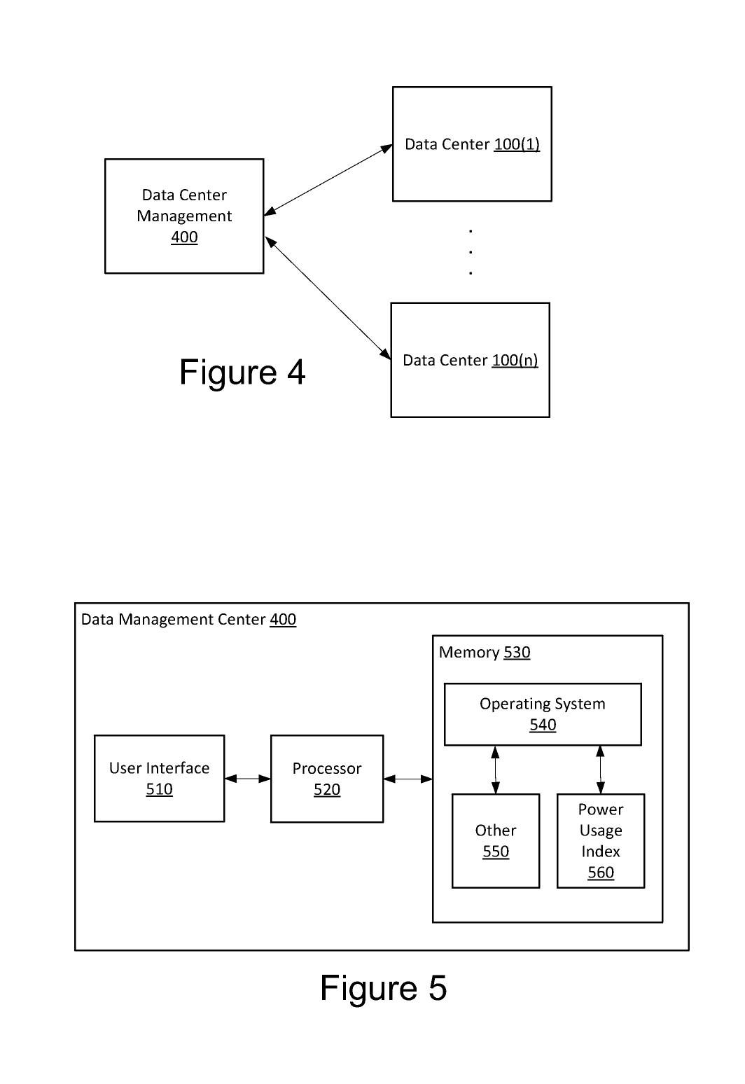

FIG. 4 is a simplified block diagram of systems, methods and/or computer program products 400 for managing a data center 100 according to various embodiments described herein. These data center management systems, methods and/or computer program products 400 may reside external to the data centers 100(1)-100(n), in a data center 100 but separate from the data center servers 110, and/or as part of one or more of the data center servers 110.

FIG. 5 is a block diagram of a data center management system, method and/or computer program product 400, according to various embodiments described herein. As shown in FIG. 5, the data center management system, method and/or computer program product 400 includes a processor 520, which may be embodied as one or more enterprise, application, personal, pervasive and/or embedded computer systems that are operable to receive, transmit, process and store data using any suitable combination of software, firmware and/or hardware and that may be standalone or interconnected by any conventional, public and/or private, real and/or virtual, wired and/or wireless network including all or a portion of the global communication network known as the Internet, and may include various types of tangible, non-transitory computer readable medium. A user interface 510 may include displays and user input devices, such as keyboards, touch screens and/or pointing devices. A memory 530 may include any computer-readable storage medium. An operating system 540 resides in the memory 530 and runs on the processor 500, as may other data center management systems, methods and/or computer program products 550. A power usage index system, method and/or computer program product 560 according to various embodiments described herein also resides in the memory 530 and runs on the processor 520.

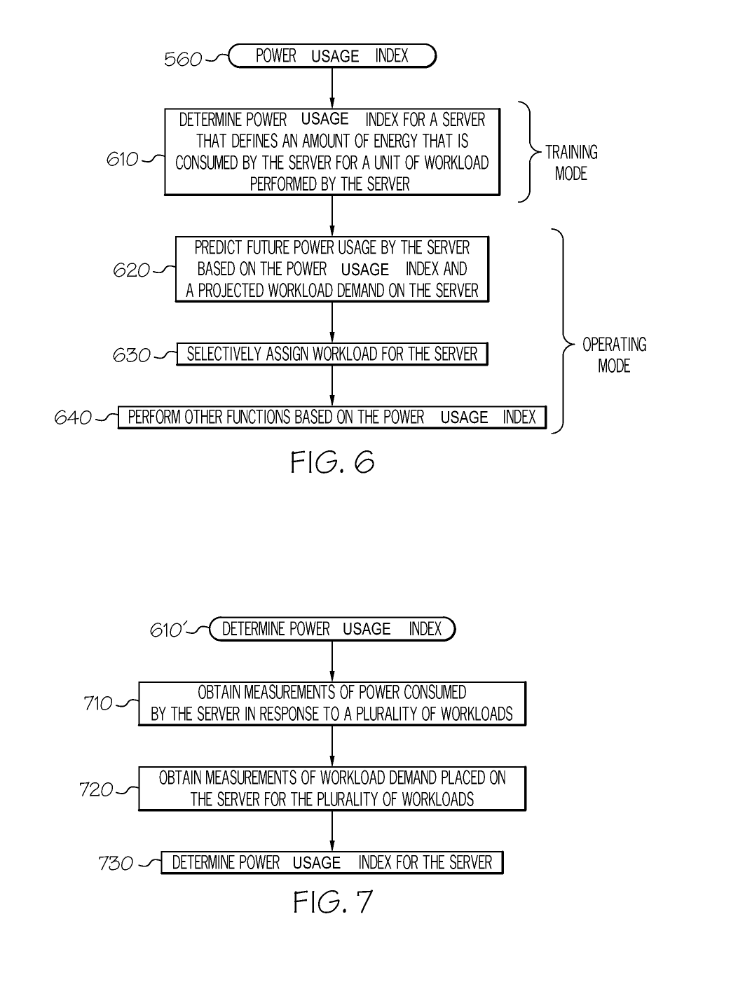

FIG. 6 is a flowchart of operations that may be performed by a power usage index system, method and/or computer program product 560, according to various embodiments described herein. Referring to FIG. 6, the power usage index may be determined at Block 610 in a training or modeling mode, and then may be used at Blocks 620-640 in an operating or predicting mode. It will be understood that the training mode of Block 610 may continue to be used to refine the power usage index, even while it is being operated in the operating mode of Blocks 620-640.

More specifically, referring to FIG. 6, at Block 610, a power usage index is determined for a server, that defines an amount of energy that is consumed by the server for a unit of workload performed by the server. Thus, a normalized portable energy consumption metric is generated that specifies energy consumption per unit of normalized computing demand.

Then, at Block 620, future power usage by the server is predicted based on the power usage index and a projected workload demand on the server. In some embodiments, workload may be selectively assigned for the server at Block 630. Specifically, workload may be assigned to the server or assigned to a different server, in response to the predicting of Block 620. Alternatively, or in addition, at Block 640, other functions may be performed based on the power usage index. For example, availability of the data center may be improved, capacity constraints may be managed, operating costs may be lowered, capital resource efficiency may be improved, financial modeling may be provided, and/or the carbon footprint of the data center may be managed.

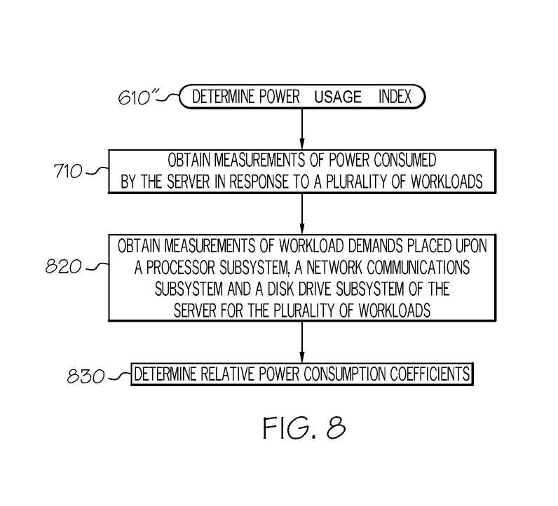

FIG. 7 is a flowchart of operations 610′ that may be performed to determine a power usage index according to various embodiments described herein. Referring to FIG. 7, at Block 710, measurements of power consumed by the server in response to a plurality of workloads are obtained. Moreover, at Block 720, measurements of workload demand placed on the server for the plurality of workloads are obtained. Then, at Block 730, the power usage index for the server is determined from the measurements of power consumed that were obtained at Block 710, and the measurements of workload demand that were obtained at Block 720. In some embodiments, a single power usage index may be determined for the server, whereas in other embodiments, a plurality of power usage indices may be obtained, which may vary as a function of workload demand placed on the server.

Additional discussion of FIG. 7 will now be provided. Specifically, referring again to Block 710, measurements of power consumed by the server in response to a plurality of workloads may be obtained by monitoring the power that is provided to the server, such as the server 110 of FIG. 1, over the power lines, such as the power lines 160 of FIG. 1, while the server performs a plurality of workloads. For example, the power consumed may be obtained using a Data Center Infrastructure Management (DCIM) computer program that is marketed by CA Technologies, and/or other DCIM tools. The CA DCIM software is described, for example, in a white paper entitled “From Data Center Metrics to Data Center Analytics: How to Unlock the Full Business Value of DCIM” by Gilbert et al., copyright 2013 CA Technologies, the disclosure of which is hereby incorporated herein by reference in its entirety as if set forth fully herein. The DCIM software includes a module called “DCIM ecoMeter” that can be used for power management. DCIM ecoMeter is described, for example, in a white paper entitled “Five steps for increasing availability and reducing energy consumption and costs across cloud and virtual platforms” to Ananchaperumal et al., copyright 2012 CA, the disclosure of which is hereby incorporated herein by reference in its entirety as if set forth fully herein. Moreover, the various workloads that are being performed by the server while the measurements of power consumption are being obtained may be determined using application performance management, workload automation and/or infrastructure management software, which is widely used for performance monitoring of servers.

Referring again to Block 720, measurements of the workload demand placed on the server for the plurality of workloads may also be obtained. One technique for determining a normalized measurement of workload demand placed on a server was developed by Hyperformix, and is described, for example, in U.S. Pat. No. 7,957,948 to Zink et al., the disclosure of which is hereby incorporated herein by reference in its entirety as if set forth fully herein; in a data sheet entitled “Hyperformix Capacity Manager Data Sheet”, Version 5.0, Copyright Hyperformix, Inc., the disclosure of which is hereby incorporated herein by reference in its entirety as if set forth fully herein; and in release notes entitled “Hyperformix® Capacity Manager™ 5.0.1”, copyright 2001-2009 Hyperformix, Inc., the disclosure of which is hereby incorporated herein by reference in its entirety as if set forth fully herein. These products develop a “Total Processing Power” metric referred to as “TPP”. The TPP metric uses data on the configuration of the server that may be obtained, for example, from a Configuration Management DataBase (CMDB) and/or an Asset Manager DataBase (AMDB). The AMDB may list the manufacturer, serial number, product name, etc. of the server, whereas the CMDB may list the specifications of the server, including processor, memory, operating system, etc., that are used to derive the TPP metric of normalized workload demand that is placed on the server for the plurality of workloads. More specifically, as described, for example, in the Zink et al. patent and referring back to FIG. 3, this normalized workload demand metric, also referred to as a “system scalability factor”, may be calculated by measuring demands placed on a processor 220 of the server, by measuring demands placed on a core 310 of the processor, on threads 320 running on the processor, and on an operating system running on the processor for the plurality of workloads. Regression analysis may be used to calculate a TPP metric for the server and/or plurality of workloads that run on the server. The TPP values may be stored in the CMDB for future use.

Referring again to Block 730, the power usage index for the server may be determined from the measurements of power consumed by the server in response to the plurality of workloads (Block 710) and the measurements of workload demand placed on the server for the plurality of workloads (Block 720). In some embodiments, the power usage index may be determined by regression analysis of the historic usage of energy (Block 710) for every known service configuration for which the TPP metric exists (Block 720).

Referring back to FIG. 6, at Block 620, future power usage by the server may be predicted using the power usage index and a projected workload demand on the server expressed, for example, in units TPP. Specifically, the future total energy demand of a given workload may be predicted using the formula:

Total_Energy_Demand_of_Workload=PEC*Projected_Computing_Demand_expressed_in_TPP. (1)

Accordingly, various embodiments of FIG. 6 can compute projected energy demand of a workload. It can use two components: the TPP metric that is currently used in the CA Hyperformix program product, and configuration data from CMDB/AMDB and/or infrastructure/application management program products.

Embodiments of FIG. 7 determine the power usage index by taking into account workload demand placed on a processor subsystem 220 of the server, and in some embodiments placed on a core of the processor subsystem 220, on threads 320 running on the processor subsystem 220 and on an operating system running on the processor subsystem 220, for a plurality of workloads. In contrast, embodiments that will now be described in connection with FIG. 8 can also take into account workload demands placed on a memory subsystem 230 of the server 110, a network communications subsystem 250 of the server 110 and a disk drive subsystem 240 of the server 110, in addition to the processor subsystem 220 of the server 110.

Referring to FIG. 8, these systems, methods and computer program products for determining a power usage index 610″ may perform the operations of Block 710 to obtain measurements of power consumed by the server in response to a plurality of workloads. Generally, power consumed by the various subsystems of the server are not known independently, but may be determined using a regression analysis as will now be described. Specifically at Block 820, measurements of workload demands placed upon a processor subsystem 220 of the server 110, a memory subsystem 230 of the server 110, a network communications subsystem 250 of the server 110 and a disk drive subsystem 240 of the server 110 may be obtained for the plurality of workloads. Measurements of workload demand placed on the processor subsystem 220 may be determined by a TPP measurement of the processor subsystem, as was described above. Measurements of the workload demands placed on the memory subsystem 230 may be obtained, for example, by monitoring a percentage usage of the memory subsystem, i.e., a percentage of the total time for which the memory subsystem is engaged in read or write operations. Measurements of the workload demand on the network communications subsystem 250 may be obtained by monitoring the percentage of network usage, i.e., the percentage of the total time for which the network communications subsystem is communicating with the processor and/or with external networks. Finally, measurements of workload demand on the storage (disk drive and network store) subsystem 240 may be determined by percent of disk active time, i.e., the percentage of the total time for which the disk drive subsystem is performing read or write operations. These measurements of TPP, percentage of memory usage, percentage of network usage and disk active time may be obtained from the server monitoring tools that were described above in connection with Block 720.

Then, referring to Block 830, relative power consumption coefficients of the processor subsystem 220, the memory subsystem 230, the network communications subsystem 250 and the disk drive subsystem 240 are determined for a unit of workload demand placed on the processor subsystem 220, the memory subsystem 230, the network communications subsystem 250 and the storage (disk drive and network store) subsystem 240. These coefficients may be stored in the CMDB for later use in predicting energy consumption.

A specific example of embodiments of FIG. 8 will now be described. Specifically, there are two general components of server power consumption: fixed and variable. Fixed components involve the basic power needed for the server when it is in an idle state. The variable component involves power consumption variation with respect to the workload of the server.

The variable component is influenced by the server subsystems and their efficiency at various operating levels. The primary subsystems are the processor (CPU) 220, memory 230, network communications 250 and storage (disk drive and network store) 240 subsystems.

Apart from these subsystems, the server fan or fans is another component that can influence the server energy consumption. Historically, CPUs were the primary producers of heat in the server and most thermal sensors were deployed in the CPU zone so that the fan was switched on when CPU was operating at high speed to dissipate the heat. However, as memory 230 has become denser, the primary heat source has shifted, so that many servers also provide a fan for the memory to control heat. In addition to CPU 220 and memory 230, fans are also often used to cool hard disk drives (HDDs). Moreover, on older servers, fans were all operated at full speed even if only one of these zones needed to be cooled. Modern servers may utilize zoned fans working in conjunction with large numbers of thermal sensors. Using information collected from these sensors, a sophisticated control algorithm can identify specific components that require cooling, and the fan speed for each zone may be adjusted accordingly so that full speed is only used where necessary.

Considering the variations of server design and build from vendor to vendor, it is desirable to understand power usage trends by server type. A data center typically hosts many different types of servers with many different generations of technology. Various embodiments described herein can generate a power usage index for every server in a data center, which can be stored as part of server details in a CMDB. A model may also be built based on historical power consumption to compute an hourly (and/or other time frame) energy consumption forecast for each type of server hosted in the data center.

Various embodiments described herein can use data from two sources: Real-time actual power consumption of the servers may be monitored, for example, around the clock, using for example DCIM software (Block 710). Also, real-time actual workloads on the server may be monitored using conventional server monitoring tools. In some embodiments, workload may be described as normalized TPP for the processor subsystem, memory usage (e.g., as a %), network traffic (e.g., as a %), and disk active time (e.g., as a %).

The following Table illustrates an example of this data collection at 1-hour intervals:

TABLE

| | | | | | Storage (disk |
|---|---|---|---|---|---|
| | | | | | drive and |
| | Power | | | Network | network store) |
| Time | Usage | | Memory | Usage | system Active |
| (hr) | (PU) (W) | TPP | (%) | (NWU) (%) | (SAT) (%) |
| 1 | 55 | 40 | 50 | 4 | 2 |
| 2 | 70 | 60 | 35 | 2 | 1 |
| 3 | 80 | 75 | 78 | 4 | 1 |

Based on the data in column 2 of the Table, an hourly and/or daily average of power usage (PU) may be computed for every server and stored in CMDB as part of the server details. Additionally, a multi-variant regression model may also be computed (Block 830) to forecast energy demand based on workload variation according to the following formula:

PU=X₁*TPP+X₂*RAM+X₃*NWU+X₄*DAT+C. (2)

Here, X1, X2, X3 and X4 correspond to correlation coefficients in the regression model between power usage and server sub-systems. C is a constant that may be determined as part of the regression model when determining the correlation coefficients. C may also be referred to as a “regression constant”.

Accordingly, the calculations described above also provide an embodiment wherein the predicting of Block 620 comprises predicting projected workload demand for the processor subsystem 220, the memory subsystem 230, the network communications subsystem 250 and the storage (disk drive and network store)subsystem 240 over a future time interval, and combining the respective projected workload demand for the processor subsystem 220, the memory subsystem 230, the network communications subsystem 250 and the storage (disk drive and network store)subsystem 240 over the future time interval and the respective relative power consumption coefficients of the processor subsystem 220, the memory subsystem 230, the network communications subsystem 250 and the disk drive subsystem 240.

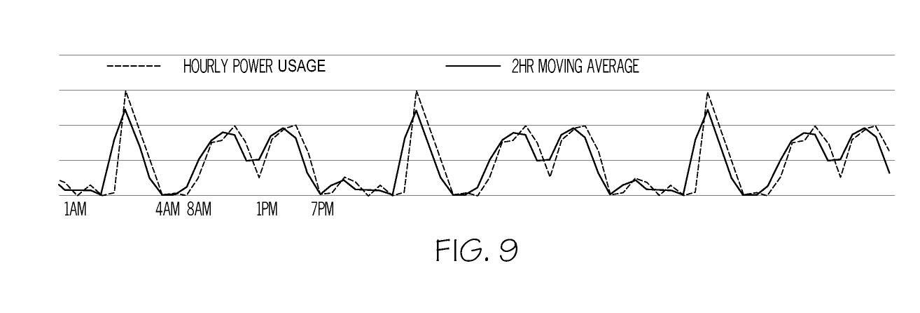

Alternatively having historical power usage data, a 2-hour (or other time frame) moving average graph can be plotted for a specific duration, and can be used as a model to predict energy consumption by server. FIG. 9 depicts an example of a moving average graph for 30 days.

Accordingly, the power usage index may be used as a differentiating factor that can be applied in multiple contexts to make informed decisions about qualifying a server with respect to energy efficiency. Scalability models may be produced for every configuration of a server in a data center. Insight may be obtained into the data center with respect to how energy efficient each server is, and for identifying high carbon contributing servers. An hourly (or other time frame) forecast model may be used to estimate energy demand for each server in a future time period. Moreover, an energy estimate may be provided for a given server with respect to workload variation.

According to various other embodiments that will now be described, non-data processing overhead, also referred to as “non-IT overhead” may be taken into account in allocating future workload among a plurality of data centers, aisles in a data center, racks in a data center and/or servers in a rack of a data center, in addition to considering power that is consumed by a server, rack, aisle and/or data center to perform a data processing workload, also referred to as “IT overhead”. An ability to predict total IT and non-IT energy use of a future workload can open up opportunities for reducing, and in some embodiments minimizing, total energy consumption by placing workload in different data centers and/or in different parts of a data center, in terms of space and/or time. Placing workload in terms of space can allow various embodiments described herein to find a physical server, rack, aisle and/or data center in such a way that the total energy expenditure may be reduced or minimized. Placing workload in terms of time may allow a time interval to be found when execution of a future workload would reduce or minimize the total energy expenditure for performing the workload.

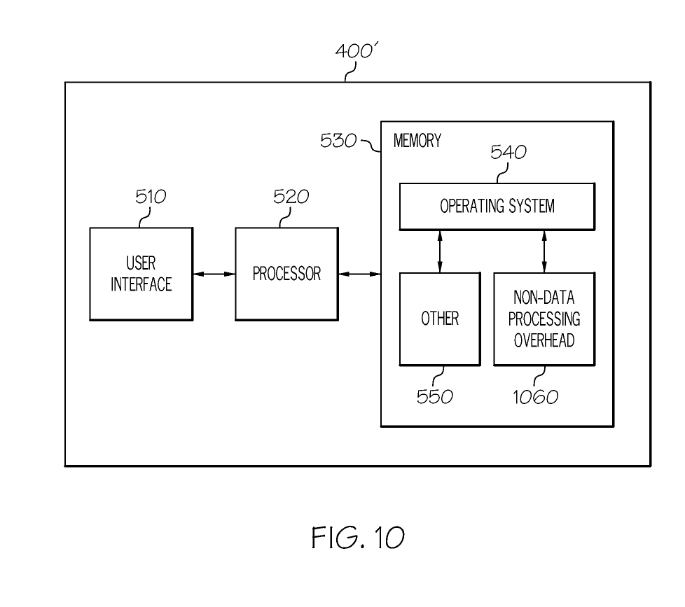

FIG. 10 is a block diagram of a data center management system, method and/or computer program product according to various other embodiments described herein. FIG. 10 is similar to FIG. 5, except that a non-data processing overhead system, method and/or computer program product 1060 according to various embodiments described herein, is also provided in the memory 530 and runs on the processor 520. As will be described in more detail below, the non-data processing overhead system, method and/or computer program product 1060 can use regression analysis against data collected by, for example, the DCIM/ecoMeter infrastructure that was already described, on a server, rack, aisle and/or data center level, by directly measuring energy that is used in a given time frame while a given workload is being executed. A model of an energy profile of a monitored unit can then be built in such a way that total energy use of a server, rack, aisle and/or data center may be measured as a function a power usage index for data processing (IT) overhead and a metric of power consumed by the unit for non-data processing (non-IT) overhead. Thus, total energy demand of a facility (rack, aisle and/or data center) may be estimated as a function of workload volume that may be placed on the facility. This estimate may be used to improve or optimize placement of future IT workload on the facility, by using load balancing, virtual machine placement, job scheduling and/or other selective assignment techniques.

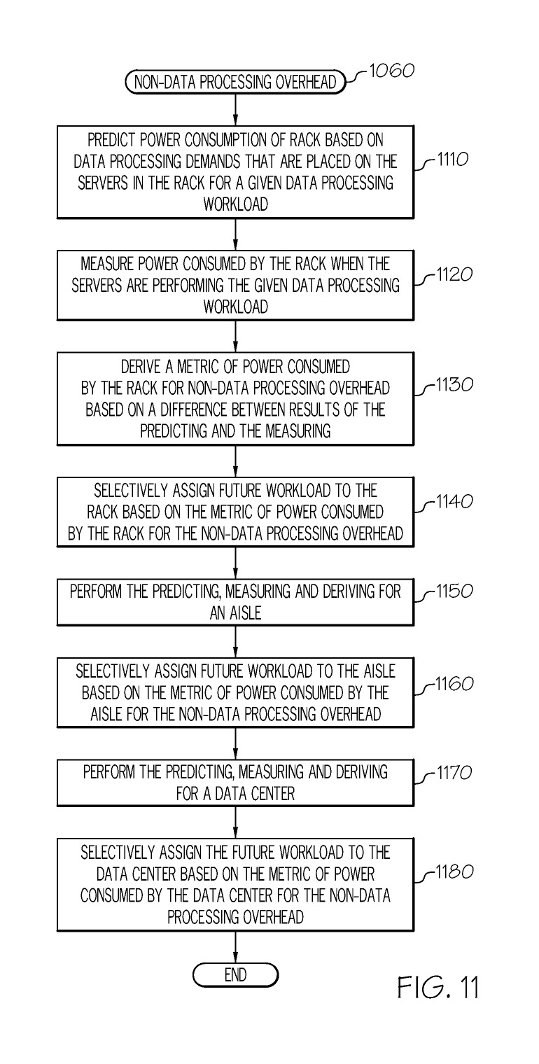

FIG. 11 is a flowchart of operations that may be performed by a non-data processing overhead system, method and/or computer program product 1060 according to various embodiments described herein. Referring to FIG. 11, at Block 1110, power consumption of a rack 120 that comprises a plurality of servers 110, is predicted based on data processing demands that are placed on the plurality of servers 110 for a given data processing workload. Any of the embodiments described in connection with FIGS. 1-9 may be used to predict power usage from the servers in the rack based on workload demand. The rack level power usage should be close to the aggregation of the power usage of the individual servers for performing the given workload based on any of the embodiments of a power usage index that were described above. Thus, the power usage (PU) per rack (R₁) can be computed by adding up all the server's usage hosted in a rack (R₁). Considering servers ranging from S₁ to Sₙ:

TotalRack PU=R₁_{_{—}}S₁_{_{—}}PU+R₁_{_{—}}S₂_{_{—}}PU+R₁_{_{—}}S₃_{_{—}}PU+ . . . +R_{_{—}}Sₙ_{_{—}}PU (3)

Note that in Equation (3) the power usage may refer to usage expressed in Watts, as opposed to percentage usage. Referring now to Block 1120, power that is actually consumed by the rack 120 when the plurality of servers 110 are performing the given data processing workload is measured, for example by measuring the power on the power line 160. In typical data centers, power consumed by the individual servers may not be able to be measured. However, power consumed by a rack 120 may be able to be measured. In other embodiments, power consumed by the individual servers 110 may also be measured and added, to obtain the measurement of power that is consumed by a rack 120. Power consumed may be measured using any of the monitoring tools that were described above.

Referring now to Block 1130, a metric of power consumed by the rack for non-data processing overhead may be derived based on a difference between results of the predicting (Block 1110) and the measuring (Block 1120). Thus, with the real time monitored data available from the monitoring tools, the power consumption from the rack (Rack_PU_direct) can be directly obtained. The ARackPU metric is the difference between the Rack_PU_direct and the Total Rack PU computed from Equation (3):

ΔRackPU=RackPU_direct−Total Rack PU. (4)

In Equation (4), ΔRackPU is the metric of power consumed by the rack for non-data processing overhead, Rack_PU_direct is the measurement of power consumed by the rack when the servers 110 are performing the given data processing workload (Block 1120), and Total Rack PU is the predicted power consumption of the rack 120 based on data processing demands (Block 1110).

At Block 1140, future data processing workload is selectively assigned to the rack 120 based on the metric of power consumed by the rack for the non-data processing overhead that was determined at Block 1130. For example, data processing workload may be assigned to a rack that is available to perform the data processing workload, and that has a low or lowest ARackPU among the available racks.

Referring now to Block 1150, the predicting (Block 1110), measuring (Block 1120) and deriving (Block 1130) may be performed for an aisle 130 that comprises a plurality of racks 120 including the rack, to derive a metric of power consumed by the aisle 130 for the non-data processing overhead. Thus, the ΔAis1ePU can also be computed by adding up all the PU at the rack level in an aisle and the ΔAisle_PU can be obtained from the difference between the Aisle_PU_direct and the Total Aisle PU computed:

Total Aisle PU=I₁_{_{—}}R₁_{_{—}}PU+I₁_{_{—}}R₂_{_{—}}PU+I₁_{_{—}}R₃_{_{—}}PU+ . . . +I₁_{_{—}}Rₙ_{_{—}}PU. (5)

ΔAislePU=Aisle_PU_direct−Total Aisle PU. (6)

In Equations (5) and (6), Total Aisle PU corresponds to the predicted power consumption of an aisle 130 that comprises a plurality of racks 120 based on data processing demands that are placed on the plurality of servers 110 in the aisle for given data processing workload, and Aisle_PU_direct is a measurement of the power consumed by the aisle 130 when the plurality of servers 110 in the aisle are performing the given data processing workload. ΔAis1ePU is the metric of power consumed by the aisle for the non-data processing overhead. At Block 1160, the future data processing workload is selectively assigned to the aisle 130 based on the metric of power consumed by the aisle 130 for the non-data processing overhead. For example, data processing workload may be assigned to an aisle that is available to perform the data processing workload, and that has a low or lowest ΔAis1ePU among the available aisles.

Referring now to Block 1170, the predicting (Block 1110), the measuring (Block 1120) and the deriving (Block 1130) may be performed for a data center 100 that comprises a plurality of aisles 130, including the aisle that was processed in Blocks 1150 and 1160, to derive a metric of power consumed by the data center 100 for the non-data processing overhead. Thus, the total data center PU can be computed by:

Total_DC_{—}ITPU_Computed=Total Aisle₁ PU+Total Aisle₂ PU+Total Aisle₃ PU+ . . . +Total Aisleₙ PU, (7)

and the ΔTotal_DC_ITPU can be obtained by:

ΔDC_{—}ITPU=DC_PU_direct−Total_DC_{—}ITPU_Computed. (8)

In Equations (7) and (8), Total_DC_ITPU Computed corresponds to the total predicted power consumption of the data center based on the data processing demands that are placed on the servers in the data center for the given data processing workload (Block 1110), and DC_PU_direct is the total measured power consumed by the data center when the servers are performing the given data processing workload (Block 1120). Δ DC_ITPU corresponds to the metric of power consumed by the data center 100 for non-data processing overhead based on a difference between results of the predicting (Block 1110) and the measuring (Block 1120).

At Block 1180, future data processing workloads are then selectively assigned to the data center based on the measure of power consumed by the data center for the non-data processing overhead. For example, data processing workload may be assigned to a data center that is available to perform the data processing workload and that has a low or lowest ΔDC_ITPU among the data centers.

It will be understood that the computation of the above Δ PUs (for a rack, aisle and/or data center) have been described as being computed serially in FIG. 11. However, all the Δ PUs can be computed concurrently and stored and/or updated on a periodic or continuous basis. These ΔPUs can be used to identify the power usages by the non-data processing overhead at respective levels (server, rack, aisle and/or data center). These findings can be used for various information, analysis and/or optimizations. For example, the ΔPUs may be displayed in a hierarchical listing that includes ΔPUs at a rack, aisle and/or data center level, and at a server level if available. The ΔPUs may also be displayed in a plan view of the data center that illustrates, for example, the layout of racks and aisles in the data center and includes the numeric values of ΔPU and/or a color coded value, on the appropriate rack and aisle in the plan view.

The measurement and prediction of power consumption for non-data processing overhead is becoming more important for data center efficiency. Specifically, data center power consumption is growing at an alarming pace. As more and more power management features grow, the dynamic range of data center power consumption is increasing and interactions among the power management strategies across subsystems may grow more complex. It may be difficult to analyze subsystems in isolation. Individual components' power consumption can vary non-linearly with localized conditions, such as temperature at the computer room air handler (CRAH) inlet or usage of the individual server. Reasoning about data center power is difficult because of the diversity and complexity of data center infrastructure. The following subsystems may primarily account for data center power draw: servers and storage systems; power conditioning systems; cooling and humidification systems; networking devices; and lighting and miscellaneous devices.

In order to forecast and/or optimize the power usage from servers with respect to workloads, it is desirable to know actual power usage at various levels like server, rack aisle and data center. Measuring at different levels helps to identify losses or non-IT overheads at all levels. Various embodiments described herein can provide methodologies to measure the overheads or losses by aggregating server level measurements and comparing them with the actual measurements at various levels. Accordingly, various embodiments described herein can selectively assign future data processing workloads among the plurality of servers in a rack, among a plurality of racks in an aisle, among a plurality of aisles in a data center and/or among a plurality of data centers, based upon metrics of power consumed by the servers, racks, aisles and/or data centers for non-data processing overhead. The selection may be based, at least in part, on reducing, and in some embodiments minimizing, the overall power consumed by the racks, aisles and/or data centers for non-data processing overhead.

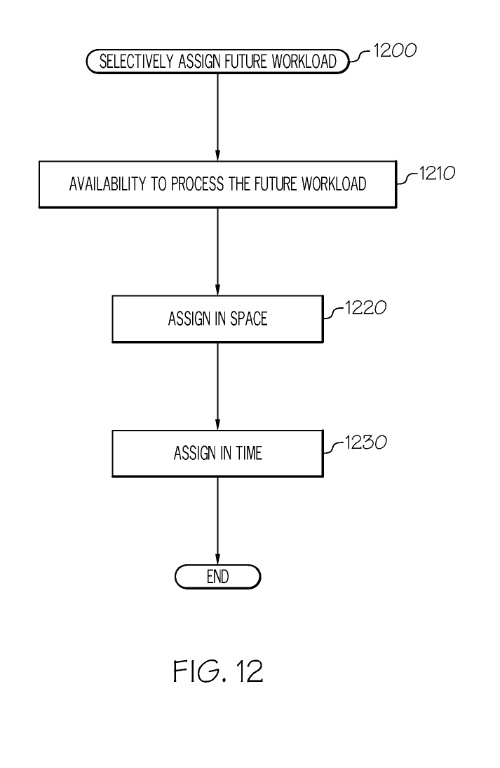

FIG. 12 is a flowchart of operations that may be performed to selectively assign future workload, which may correspond to the operations of Blocks 1140, 1160 and/or 1180 of FIG. 11. Referring to FIG. 12, at Block 1210, a determination is first made as to whether the data center, rack or aisle is available to process the future workload. Stated differently, a determination is made as to whether data processing capacity is available at the data center, aisle, rack and/or server level. This determination may be made using the predicted TPP, memory, NWU and/or DAT metrics of the data centers, aisles, racks and servers as was described in connection with the Table above. Assignment may then take place in space at Block 1220 and/or in time at Block 1230.

Assignment in space (Block 1220) may take place by selecting a data center from a plurality of data centers, an aisle in the selected data center from a plurality of aisles in the selected data center, a rack in the selected aisle from a plurality of racks in the selected aisle and/or a server in the selected rack from among a plurality of servers in the selected rack, to reduce, and in some embodiments minimize, the overall power consumed for the non-data processing overhead in processing the future workload. Assignment in time (Block 1230) may also be performed to reduce, and in some embodiments minimize, a cost of the power consumed for the non-data processing overhead in performing the future workload. More specifically, power costs may be set by an electric utility to reduce power usage during peak demand times. Moreover, large energy consumers, such as data centers, may be provided other cost preferences when reducing peak demand. For example, projected energy usage for many data centers during a future time frame (e.g., one hour) may be compared, and future workload may be shifted in space to the data center with lowest projected energy usage and/or in time to an even later time. Accordingly, workload may be reassigned (rescheduled) in time to take advantage of these favorable rates and/or other incentives to reduce the overall cost of power consumed for non-data processing overheads.

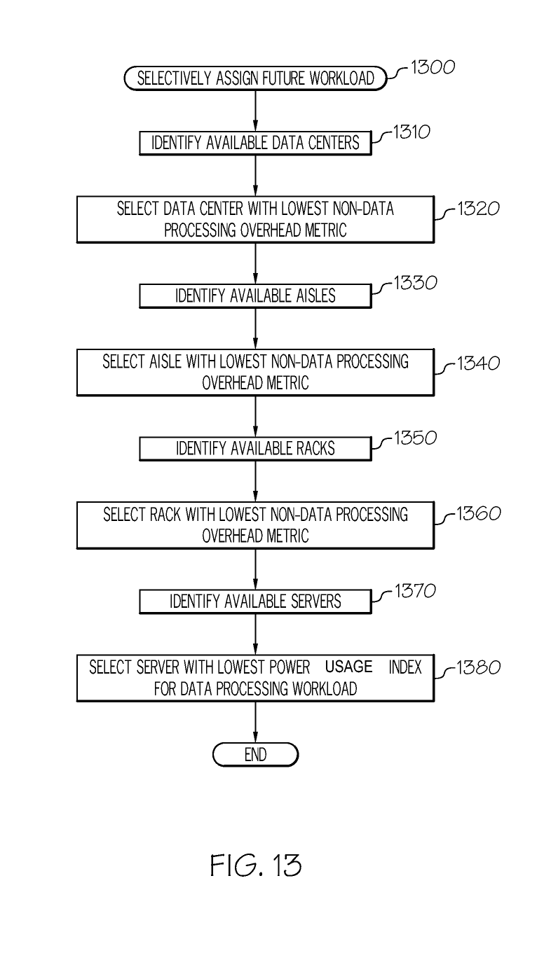

FIG. 13 is a flowchart of operations that may be performed to selectively assign future workload according to other embodiments described herein. In embodiments of FIG. 13, a top-down assignment is performed by selecting a data center 100, an aisle 130 within the data center, a rack 120 within the aisle, and a server 110 within the rack.

More specifically, referring to FIG. 13, at Block 1310, a plurality of data centers 100 are identified that are available, i.e., that have capacity, to perform the future workload. At Block 1320, a data center 100 from among the plurality of available data centers is selected having a low or lowest non-data processing overhead metric, i.e., a lowest Δ DC_ITPU (Equation 8). At Block 1330, aisles 130 within the selected data center 100 are identified that are available to perform the future workload. At Block 1340, an aisle is selected from among the available aisles that are identified, having a low or the lowest non-data processing overhead metric, i.e. with a low or the lowest Δ Aisle_PU (Equation 6). At Block 1350, a plurality of racks 120 in the selected aisle 130 are identified that have capacity to perform the future workload. At Block 1360, a rack 120 is selected from the available racks, having a low or the lowest non-data processing overhead metric, i.e., the lowest ΔRackPU (Equation 4). At Block 1370, servers 110 within the identified rack 120 that are available to perform the future workload are identified. At Block 1380, assume that a Δ PU is not available for the servers, because these individual power consumption measurements are not available at the server level. Then, an available server 110 with a low or the lowest power usage index for the data processing workload is selected. Accordingly, embodiments of FIG. 13 use the metrics of power consumed for non-data processing overhead to select a data center 110, aisle 130 and rack 120, and then use a power usage index that defines an amount of power that is consumed for a unit of workload performed by a server 110 to select a server 110 in the rack 120.

It will also be understood that other embodiments of FIG. 13 may begin at the aisle 130 or rack 120 level rather than at the data center 100 level, and may combine metrics of power that is consumed by a data center, aisle, rack and/or server, to perform both data processing tasks and non-data processing overhead. It will also be understood that various embodiments of FIG. 13 provided a “top down” assignment from data center to aisle to rack and to server. In other embodiments, the selective assignment may be performed only at a single level. For example, an available rack may be found with a low or the lowest non-IT overhead, regardless of the aisle in which it is located. Alternatively, an available aisle may be found with a low or the lowest non-IT overhead regardless of the data center in which it is located. Stated differently, the assignment may find a low or lowest available non-IT overhead rack, even if it is not located in a low or lowest available non-IT overhead aisle or in a low or lowest available non-IT overhead data center.

Accordingly, various embodiments described herein can allow efficiency to be discovered at different levels: rack, aisle, and data center. Objective techniques have been described to measure the aisle and rack level placement efficiency. Thus, according to various embodiments described herein, before placing a job (transaction and/or batch), priority may be given to efficient racks first for better throughput. The same behavior can be extended to aisle and data center level placement of jobs. In some embodiments, regression analysis may be used against data that is collected by DCIM/ecoMeter and/or other monitoring systems on a server, rack, aisle and data center level, by directly measuring energy used in a time period while workload is being executed. A model of an energy profile for a monitored unit may be built, so as to create a formula that allows an estimate of total energy use of a server, rack, aisle or data center as a function of processing workload.

Energy Efficient Assignment of Workloads to Servers

In some embodiments, a workload is allocated to servers based on energy considerations. This workload could be a projected workload over some time period, such as the next 24 hours. The selected allocation could minimize total energy consumption, reduce peak energy consumption, keep energy consumption below a threshold during some sub-interval, spread out energy consumption, optimize energy consumption, etc. The workload could be allocated amongst different servers in one or more data centers. Thus, a suitable allocation of the workload to servers in one or more datacenters may be selected to meet one or more energy consumption goals.

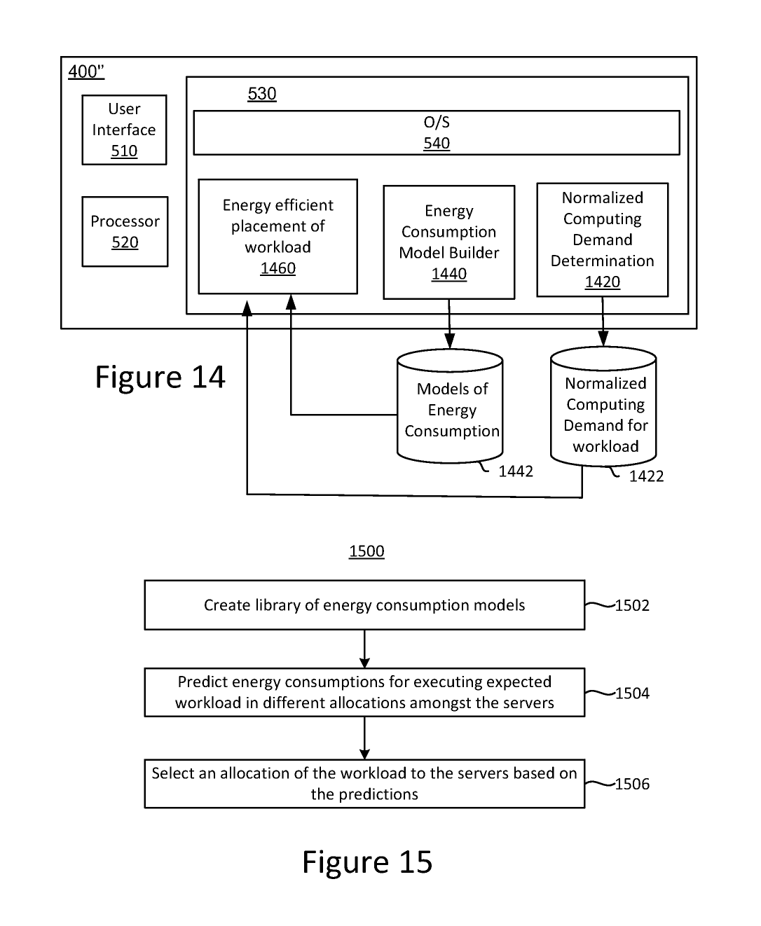

FIG. 14 is a diagram of a system 400″ that determines how to place a workload on servers based on energy consumption considerations, in accordance with embodiments. The system 400″ may be used for managing a data center 100. The system 400″ is similar to the ones of FIGS. 5 and 10; however, system 400″ has normalized computing demand for workload 1420, energy consumption model builder 1440, and energy efficient placement of workload 1460. Each of normalized computing demand for determination 1420, energy consumption model builder 1440, and energy efficient placement of workload 1460 may include processor executable instructions and/or data structures that are stored in memory 530. The processor executable instructions may be executed on the processor 520 to implement various methods described herein. The processor executable instructions and/or data structures that are stored in memory 530 may constitute a computer program product.

Specifically, the normalized computing demand determination 1420 is able to determine normalized computing demand for some workload. Determining the computing demand for some workload may include determining computing demand for any portion of the workload. For example, the computing demand of a particular batch job might be determined. Once a workload is characterized in terms of normalized computing demand, that characterization may be stored as a normalized computing demand for the workload 1422. The normalized computing demand may be expressed as one or more scalability factors, which is further discussed below.

Various metrics may exist that can provide a normalized unit of computing demand that is placed on an Information Technology (IT) infrastructure in a data center. One such metric is referred to as Total Processing Power (TPP) that was developed by Hyperformix, Inc., and is now embodied, for example, in the computer programs “CA Capacity Manager” and “CA Virtual Placement Manager”, both of which are marketed by CA, Inc. As noted above, this metric may be thought of as being similar to Millions of Instructions Per Second (MIPS) in mainframe technology.

In some embodiments, the normalized computing demand for the workload is broken down into demand for various resources, such as, but not limited to, a CPU, network, disk I/O, and memory. In one embodiment, there is a separate TPP metric for each resource.

The energy consumption model builder 1440 is able to build a model of energy usage for various servers and/or server configurations. An example of different parameters for the server configuration could include an operating system type, processor chip type, processor clock speed, number of chips in the system, number of cores per chip, number of processor threads per core. This list is exemplary in that not all these parameters need be used, and other not listed could be used.

The model for a given server (or server configuration) may define an amount of power that is consumed by the server for a unit of workload performed by the server. A server can have different resources including, but not limited to, a CPU, network, disk I/O, and memory. Note that the different servers may be provided by different vendors, in some cases. The model may be used to forecast energy usage in terms of a normalized unit of computing demand (e.g., TPP) for one or more of the resources of the server. The model may also factor in environmental conditions, such as temperature, humidity, etc. The models are stored in the library of energy consumption models 1442.

The energy efficient placement of workload 1460 is able to determine how to allocate a workload amongst the servers, based on energy considerations. Note that the workload may be characterized in terms of the normalized unit of computing demand (e.g., TPP). The models for the servers may be characterized in terms of the normalized unit of computing demand. Specifically, the model may predict energy consumption for a normalized unit of computing demand. Thus, the normalized unit of computing demand may serve as a common parameter that can be used to assist in determining how to allocate the workload based on energy considerations.

Embodiments disclosed herein allocate a “workload” amongst servers. The following is a brief discussion of a “workload.” A “workload” is a stream of one or more requests for information system services. A workload may be interactive (e.g., Online Transaction Processing (OLTP), and/or transactional processing in general), in which case the workload stream consists of discrete transactions that arrive periodically from users or other systems external to the information system. Each transaction is processed by the information system and, when completed, a reply is sent to the submitting user or system. Examples include stock purchases at a financial services website and product purchases at an e-commerce website. A workload may include batch jobs that execute according to a schedule specified by business owners or IT administrators. Example batch jobs include server and storage system backups and bulk database updates. In each case, each transaction or batch job may be processed by multiple application components executing on multiple servers or other infrastructure components. The processing of each such transaction by an application component consumes computing resources (such as CPU or memory resources) and physical resources such as energy.

The definition of a particular workload in particular information systems is flexible. Some IT and business professionals prefer to manage their systems using workloads defined at gross levels of granularity, whereas other IT and business professionals prefer to manage their systems using finer-grained definitions, such as “Human Resources Recruitment Transactions” versus “R&D Project Management Transactions”.

Note that for purposes of discussion the term “workload” may refer to all of the transactions and/or batch jobs over some time interval. For example, the system can allocate the projected workload for the next 24 hours to various servers based on energy considerations. Using the term “workload” in this manner, the term “portion of the workload” or the like may refer to any subset of this workload.

In embodiments herein, the behavior of a workload or any portion thereof is characterized in a portable way that is invariant under arbitrary scenarios. For example, if we define a scenario such as “what happens if we move workloads X, Y and Z from data center A to data center B”, the portable characterizations of workloads X, Y and Z derived from analysis of their history in data center A will apply unchanged to our analysis of their potential execution in data center B. To predict the actual computing and physical resource consumption in each scenario, embodiments apply system component scalability models to the workload characterizations. The scalability models are independent of the workloads and the workload characterizations are independent of the system components. This decoupling of specification significantly simplifies modeling and allows accurate “apples to apples” comparisons of different scenarios.

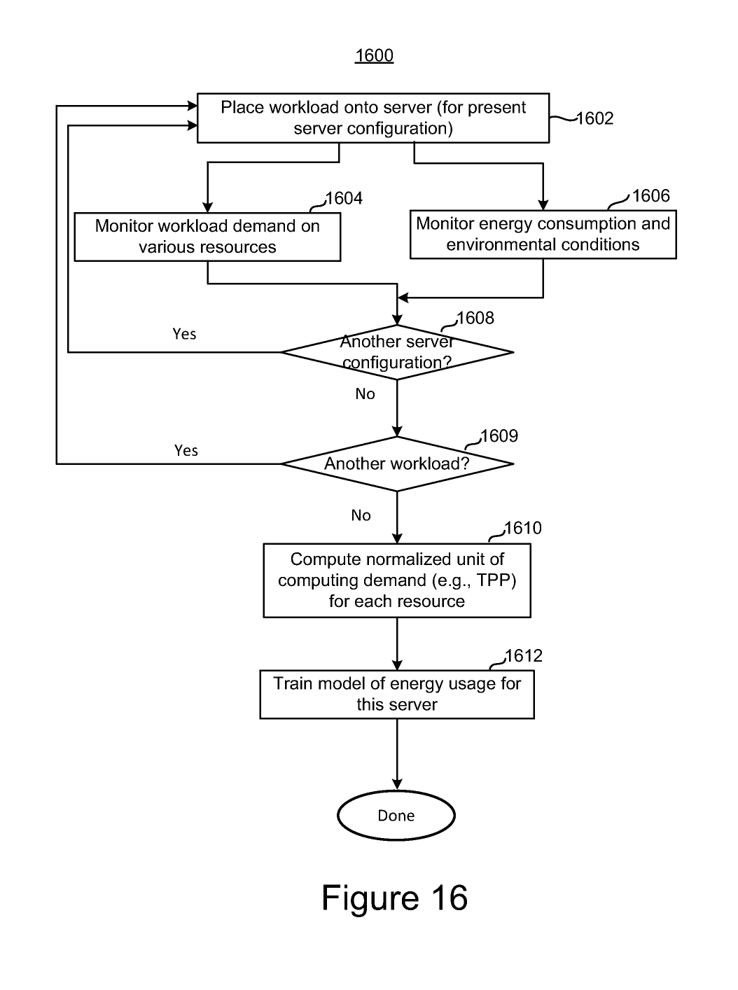

FIG. 15 is a flowchart of one embodiment of a process 1500 of allocating a workload to servers based on energy considerations. The process 1500 could be performed by system 400″. In step 1502, a library of energy consumption models 1442 is created. Step 1502 may include training an energy consumption model for each server (or server configuration). An example of different parameters for the server configuration could include an operating system type, processor chip type, processor clock speed, number of chips in the system, number of cores per chip, number of processor threads per core. Step 1502 can be based on monitoring energy consumption of various resources of a server in response to various workloads placed on the server. Environmental conditions may also be monitored. Further details are discussed with respect to FIG. 16.

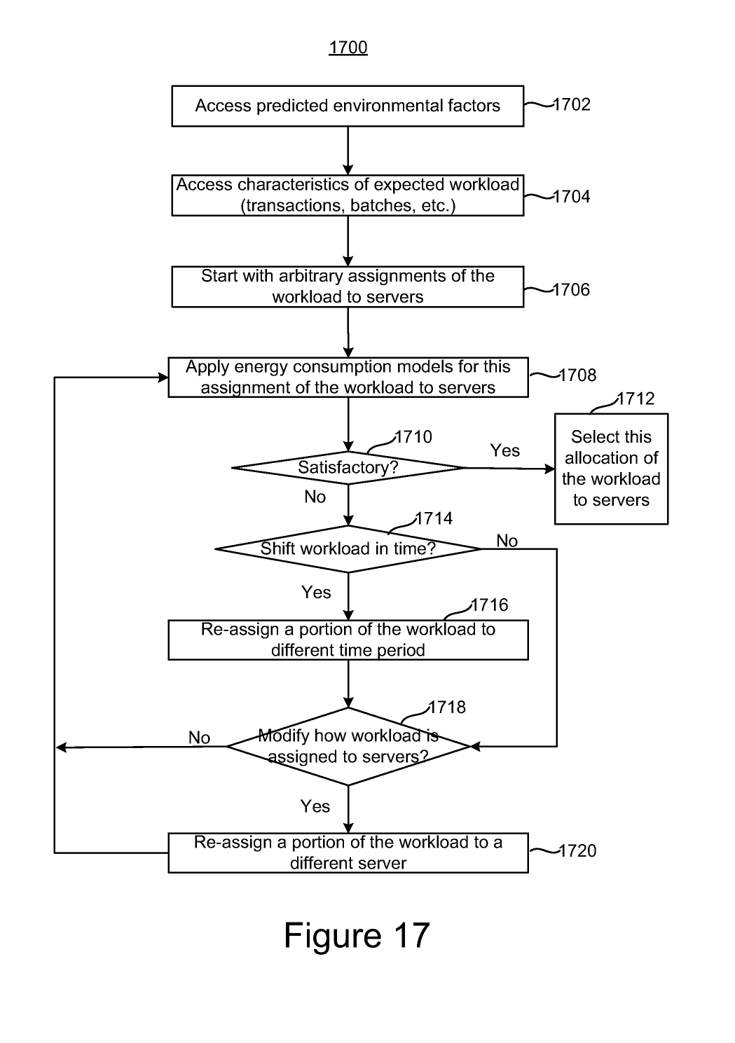

In step 1504, energy consumption is predicted for executing an expected workload on different servers. This workload could be the expected workload over some time period, such as the next 24 hours. Step 1504 may include applying the models of energy consumption 1442 to predict how various allocations of the workload to the servers will consume energy. The workload can be varied in how it is allocated among the servers, as well as how it is allocated in time. The energy consumption of these different allocations can be predicted based on the models of energy consumption 1442. Further details are discussed with respect to FIG. 17.

In step 1506, one of the allocations of the workload to the servers is selected based on the energy consumption predictions of step 1504. A variety of factors can be used to select the allocation. This could be to minimize overall energy consumption, but that is just one possibility. This could also be to reduce peak energy consumption, shift energy consumption to a different time interval, optimize energy consumption, etc.

FIG. 16 is a flowchart of one embodiment of a process 1600 of creating a library of energy consumption models 1442. Process 1600 trains an energy consumption model for various server configurations. Note that a given datacenter might have numerous servers having the same configuration. Therefore, the process need not be performed for every server in a datacenter.

In step 1602, a workload is placed onto a server. As noted, a workload may be defined as a stream of requests for information system services. The workload that is placed on the server may be any portion of that stream of requests. For example, it could be some batch job or some portion of the batch job. Note that a batch job could execute on more than one server. Thus, step 1602 may include placing a relevant portion of the batch job on the server under test. As another example, the workload that is placed on the server could be a stream of transactions (or some portion each transaction in that stream). Note that execution of a given transaction can occur over more than one server. Thus, the server under test might only execute some aspect of a given transaction.

The server being tested may be characterized in terms of its configuration. Thus, other servers with the same configuration can be expected to have the same energy consumption model. An example of different parameters for the server configuration could include an operating system type, processor chip type, processor clock speed, number of chips in the system, number of cores per chip, number of processor threads per core, a measured single thread performance S-meas, a measured throughput performance rate R_meas. The measured single thread performance S-meas and the measured throughput performance rate R_meas may be accessed from published data, but that is just one option. These parameters could be measured experimentally. An example of published data for these last two parameters is the SPECint2006 and the SPECint_rate2006 from Standard Performance Evaluation Corporation.

In step 1604, monitoring is performed of workload demand on various resources associated with the server under test. The resources could include CPU, network, disk I/O, and/or memory. This is a non-exhaustive list. Note that any subset of resources could be monitored. The monitoring may include monitoring the following: processor usage (e.g., as a %), memory usage (e.g., as a %), network traffic (e.g., as a %), and disk active time (e.g., as a %). The workload that is being performed by the server may be determined using application performance management, workload automation and/or infrastructure management software, which is widely used for performance monitoring of servers.

In step 1606, monitoring is performed of energy consumption on various resources associated with the server. Additionally, various environmental conditions such as temperature and humidity are monitored. For example, the power consumption may be obtained using a Data Center Infrastructure Management (DCIM) computer program that is marketed by CA Technologies, and/or other DCIM tools. The CA DCIM software is described, for example, in a white paper entitled “From Data Center Metrics to Data Center Analytics: How to Unlock the Full Business Value of DCIM” by Gilbert et al., copyright 2013 CA Technologies, the disclosure of which is hereby incorporated herein by reference in its entirety as if set forth fully herein. The DCIM software includes a module called “DCIM ecoMeter” that can be used for power management. DCIM ecoMeter is described, for example, in a white paper entitled “Five steps for increasing availability and reducing energy consumption and costs across cloud and virtual platforms” to Ananchaperumal et al., copyright 2012 CA, the disclosure of which is hereby incorporated herein by reference in its entirety as if set forth fully herein.

In step 1608 it is determined whether there is an additional server configuration to test for this workload. If so, the process returns to step 1602 to place the present workload onto a server with the next configuration to be tested. Otherwise, control passes to step 1609.

In step 1609 it is determined whether there is an additional workload to place onto various server configurations and monitor. If so, the process 1600 returns to step 1602. For example, a different batch job (or relevant portion thereof) is placed on a server. As another example, a different stream of transactions (or relevant portion of each transaction in that stream of transactions) is placed on the server. If not, control passes to step 1610.

In step 1610, a normalized unit of computing demand (e.g., TPP) is determined for each resource for this workload. For example, there could be a separate TPP for CPU, network I/O, disk I/O and memory. The TPP for network I/O and disk I/O could be measured in terms of memory units per second (e.g., Megabits/second). The TPP for memory could be measured in terms of memory units (e.g., Megabits).

One technique for determining a normalized measurement of demand placed on various resources was developed by Hyperformix, and is described, for example, in U.S. Pat. No. 7,957,948 to Zink et al., the disclosure of which is hereby incorporated herein by reference in its entirety as if set forth fully herein; in a data sheet entitled “Hyperformix Capacity Manager Data Sheet”, Version 5.0, Copyright Hyperformix, Inc., the disclosure of which is hereby incorporated herein by reference in its entirety as if set forth fully herein; and in release notes entitled “Hyperformix® Capacity Manager™ 5.0.1”, copyright 2001-2009 Hyperformix, Inc., the disclosure of which is hereby incorporated herein by reference in its entirety as if set forth fully herein. These products develop a “Total Processing Power” metric referred to as “TPP”. The TPP metric uses data on the configuration of the server that may be obtained, for example, from a Configuration Management DataBase (CMDB) and/or an Asset Manager DataBase (AMDB). The AMDB may list the manufacturer, serial number, product name, etc. of the server, whereas the CMDB may list the specifications of the server, including processor, memory, operating system, etc., that are used to derive the TPP metric of normalized demand that is placed on the server for the plurality of workloads. More specifically, as described, for example, in the Zink et al. patent, this normalized demand metric, also referred to as a “system scalability factor”, may be calculated by measuring demands placed on a processor 220 of the server, by measuring demands placed on a core 310 of the processor, on threads 320 running on the processor, and on an operating system running on the processor for the plurality of workloads. Regression analysis may be used to calculate a TPP metric. The TPP values may be stored in normalized computing demand 1422 for future use.

In step 1612, a model of energy usage is trained for the present server (and hence server configuration). This may be based on results of monitoring the energy consumption (step 1606), as well as the normalized unit of computing demand for each resource (step 1610). Training the models may also be based on published energy efficiency data. The published energy efficiency data is further discussed below.

In some embodiments, the model of energy usage for a specific server configuration may be determined by regression analysis of the energy usage for the various workloads on a server having that configuration.

In one embodiment step 1612 solves for correlation coefficients in Equation 9:

Watts=a+b*TPP(CPU)+c*TPP(Memory)+d*TPP(Network)+e*TPP(Disk I/O)+e*Temperature+fHumidity (9)

The model of energy usage for this server configuration is stored in the library 1442. In Equation 9, values are determined for each of the correlation coefficients (a-f) for each server (or server configuration). Here, a-f correspond to correlation coefficients in the regression model between power usage and server sub-systems (e.g., CPU, Memory, Network, Disk I/O). In essence, these correlation coefficients (a-f) are what distinguish one server's (or server configuration's) predicted energy consumption from another. For example, correlation coefficient “b” characterizes the sensitivity of energy consumption of the server to CPU energy consumption.

To predict energy consumption for a given workload, TPP values for the workload may be input to Equation 9. Thus, the TPP values are what distinguish one workload's predicted energy consumption on a given server from another workload.

As noted above, building the models in step 1612 may be based on published energy efficiency data. This data can help to build scalability models (e.g., CPU scalability models). This published energy efficiency data could be the previously discussed measured single thread performance S-meas and measured throughput performance rate R_meas. However, these parameters could be measured experimentally rather than accessed from published data, such as the SPECint2006 and the SPECint_rate2006 from Standard Performance Evaluation Corporation. In one embodiment, scalability factors include four linear scalability factors and four exponential scalability factors. The scalability factors determine a linear and exponential fit for operating system (OS) scalability, chip scalability, core scalability, and thread scalability, in one embodiment. Further details of determining scalability factors are described in U.S. Pat. No. 7,957,948, which has previously been incorporated by reference.

FIG. 17 is a flowchart of one embodiment of a process 1700 of allocating a workload to servers based on energy considerations. This process may be applied for a workload to be executed in one or more datacenters. This workload may be an estimated workload for some future time period. For example, it could be an estimate of the workload to occur over the next 24 hours. Process 1700 is one embodiment of steps 1504 and 1506 of FIG. 15. Process 1700 involves iteratively applying the energy consumption models 1442 while varying the allocation of the workload to the servers.

In step 1702 predicted environmental conditions are accessed. These conditions could include temperature and humidity, as examples. These are for environmental conditions in which the servers reside. There could be different environmental conditions for different servers, for different datacenters, etc. These environmental conditions could be predicted based on past environmental conditions, as one example.

In step 1704 characteristics of a workload to be executed in the datacenter(s) are accessed. In one embodiment, the workload is characterized in terms of a normalized unit of computing demand (e.g., TPP). This may be broken down on basis of demand for each of a plurality of resources. For example, referring back to Equation 9, the workload can have values for each of TPP(CPU), TPP(Memory), TPP(Network), and/or TPP(Disk I/O). Note that these are examples and TPP values could be used for other resources.

The workload might include transactions and/or batch jobs. For example, a transaction aspect of the workload could be characterized in terms of a number of transactions per unit time for different periods of the day. As a more particular example, there could be a transaction rate for each hour of the day. A batch aspect of the workload could be specified as particular batch jobs to be performed. The time period for performing a given batch job could be flexible. For example, a given batch job might be specified to be performed sometime in the next 24 hours, by a certain time of the day, etc.

In step 1706 an initial allocation of the workload to the servers is assumed. Initially, the assignment of the workload to the servers may be arbitrary. The assignment may spread out the workload in both space and time. That is, the workload may be allocated to different servers, as well as to different time periods. For example, batch jobs can be initially allocated to any time period that is suitable. The process 1700 will iteratively refine this assignment (steps 1708-1720) to find an acceptable solution.

In step 1708, the energy consumption models 1442 for the servers are applied for how the workload is presently allocated. Step 1708 predicts energy consumption if the workload were to be placed on the servers in the present allocation. Note that the model for each server (or server configuration) can be used to predict an energy usage for that server. Note that step 1708 will be repeated for different allocations of the workload to the servers. The energy consumption for this allocation is stored for comparison with other allocations.

Step 1710 is a conditional that determines whether the energy consumption is satisfactory. This test could be to examine the energy consumption for one or more targets. As one simple example, the goal might be to minimize energy consumption over a 24 hour period. Step 1710 could compare the total energy consumption for each configuration to look for a minimum. Step 1710 could instead look to be sure the peak energy consumption is less than some target.

If the energy conditions are met, the present allocation of the workload to the servers is selected, in step 1712. The workload may be scheduled for placement according to the selected allocation. If the determination of step 1710 is that the energy consumption is not satisfactory, then control passes to step 1714.

In step 1714, a determination is made as to whether the workload should be shifted in time. Note that it might be desirable to keep the peak energy consumption below some threshold. In this case, it could be desirable to shift some portion of the workload to another time period. For example, a batch job could be shifted in time. If step 1714 is yes, then control passes to step 1716 to assign a portion of the workload to a different time period relative to its present allocation. Then control passes to step 1718. Otherwise, control passes directly to step 1718.

Step 1718 is a conditional to determine whether to modify how the workload is allocated to the servers. As one example, a certain portion of the workload might be performed more efficiently on a different server. Thus, that portion can be re-allocated to achieve a more energy efficient solution, at step 1720. There are a variety of ways in which a portion of the workload can be re-assigned.

Then, control passes to step 1708 to again apply the energy consumption models 1442 to determine energy consumption for this new workload allocation. Note that this time around, the workload might be: 1) shifted in time but not allocated differently amongst the servers; 2) allocated differently amongst the servers but not shifted in time; or 3) shifted both in time and in allocation among the servers. Note that the shift might shift a portion of the workload from one datacenter to another. Eventually, step 1710 should result in a satisfactory condition, in which case the workload is scheduled in step 1712.

In one embodiment, steps 1714 and 1718 are performed using a search algorithm that finds a new way to allocate the workload amongst the servers. One example of a search algorithm is a “hill climbing algorithm.” A hill climbing algorithm may allow the configuration to improve rapidly since there is strong domain knowledge that provides a strong hint about the steepest path up the hill. For example, a certain portion of the workload might perform more efficiently (energy-wise) if it is allocated to a server that performs CPU intensive activities in an energy efficient manner relative to one that performs CPU intensive activities in a less an energy efficient manner. On the other hand, a different portion of the workload might perform more efficiently (energy-wise) if it is allocated to a server that performs disk I/O intensive activities in an energy efficient manner relative to one that performs disk I/O intensive activities in a less an energy efficient manner. The correlation coefficients from Equation 9 may be used to determine the relative efficiencies of the different servers.

Many other types of search algorithms can be used. Other example search algorithms include, but are not limited to, gradient Ascent Algorithms and Genetic Algorithms.

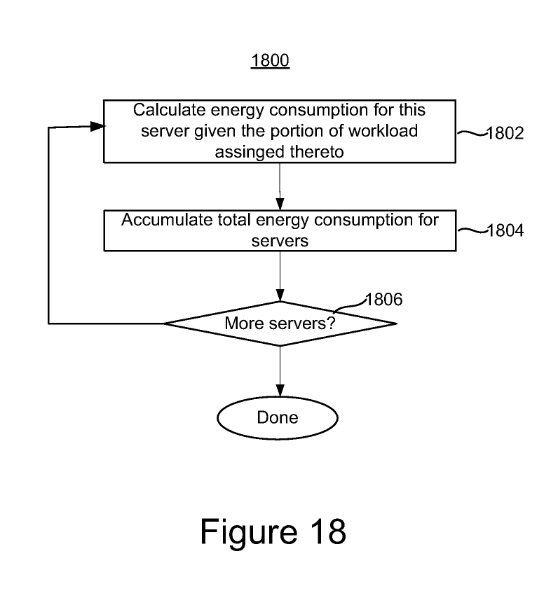

FIG. 18 is a flowchart of one embodiment of a process 1800 of predicting energy consumption for a specific allocation of the workload to servers. This process is one embodiment of step 1708 of process 1700. This process predicts energy consumption for some period of time, such as the next 24 hours. The process will be explained with reference to predicting energy usage for a 24 hour period, with the understanding that this is for purpose of illustration. Process 1800 may be repeated with each loop of process 1700 in order to predict energy usage for a different allocation of the workload to the servers.

In step 1802, the energy that a specific server is predicted to consume for the 24 hour period is computed. Note that this prediction can be broken down into separate predictions for various time intervals. For example, step 1802 could predict energy consumption in one minute time periods, or any other period. In one embodiment, Equation 9 is used. Recall that Equation 9 is for predicting power usage in Watts. As is well understood, energy usage can be determined based on power usage over some time interval.

The nature of the workload that is executed on a given server may change over the 24 hour period. For example, the workload on the server for the first hour might be processing a stream of transactions at a rate of x transactions/second. The workload on the server for the second hour might be processing a stream of transactions at a rate of y transactions/second. The calculation of step 1802 may factor in the changing nature of the workload on this server during the 24 hours. Note that these changes are for one specific allocation of the 24 hour workload to the servers. That is, these changes are not referring to the changes in workload allocation that are performed in steps 1714-1720 of process 1700.

Step 1804 is to accumulate the energy consumption of this server with other servers. The total energy consumption may be over any time period. As one example, the total energy that all servers are predicted to use for the entire 24 hours is accumulated. As another example, the total energy that all servers are predicted to use over one minute increments for the entire 24 hours is accumulated. This later total can be useful in generating a graph of predicted energy usage over time.

Step 1806 determines whether there are more servers to process. If so, control passes to step 1802 to predict energy consumption for the next server.

Referring back to FIG. 17, step 1710 is to determine whether the predicted energy usage is satisfactory. By being satisfactory it is meant that the predicted energy consumption meets some criterion (or criteria). In one embodiment, the criterion is to minimize total energy consumption over the 24 hour period. Therefore, process 1800 is repeated with different allocations of the workload until a minimum energy consumption is found. The search algorithm in process 1700 can be performed in a manner that tends to examine more energy efficient allocations with each iteration. The process 1700 may be performed until the total energy consumption no longer drops with a new allocation of workload (or the drop is not significant).

In one embodiment, the criterion is to keep the maximum energy usage below some target level. In this case, step 1710 may determine that energy usage for some time period is too high. In this case, when the workload is re-allocated, it can be re-allocated in a manner that shifts energy usage out of the time period of energy over-use. Thus, the re-allocation of the workload may be based on the results of step 1708.

In one embodiment, the criterion is to keep the energy usage reasonably constant. In this case, a graph of energy usage over time can be analyzed to determine whether workload should be shifted from a period of over-use and/or to a period of under-use. Process 1700 can be repeated until the energy usage is constant (to within some tolerance).

In one embodiment, the criterion is to prevent energy usage spikes (but not necessarily constant energy usage). In this case, a graph of energy usage over time can be analyzed to determine whether there are spikes in predicted energy usage. Process 1700 can be repeated until there are no spikes (to within some tolerance).

The foregoing are a few examples of how predicted energy use can be used to assign the workload to the servers. Many other aspects of predicted energy use could be used as a criteria in step 1710. Also, any of these criterion may be combined, such that multiple criteria may be used in step 1710.

One embodiment includes a system comprising a processor configured to perform the following. The processor trains energy consumption models. Each of the energy consumption models is for a server. Each energy consumption model forecasts energy usage in terms of a normalized unit of computing demand on the respective server. The processor predicts energy consumption for the workload in different allocations of the workload to the servers. This prediction is based on the energy consumption models for the respective servers. The processor selects an allocation of the workload to the servers based on the predicted energy consumption for the different allocations.

One embodiment includes a computer program product comprising a computer readable storage medium having computer readable program code embodied therewith. The computer readable program code comprises computer readable program code configured to do the following. The computer readable program code is configured to create energy consumption models for different server configurations. Each server configuration comprises various resources. Creating the energy consumption models comprises building each respective energy consumption model to forecast energy usage in terms of a normalized unit of computing demand for each of the resources of the respective server configuration. The computer readable program code is configured to access characteristics of a workload. The workload is characterized in terms of the normalized unit of computing demand for each of the resources. The computer readable program code is configured to predict energy consumption for the workload in different allocations to servers in a datacenter. Each of the servers has one of the server configurations. The computer readable program code predicts energy usage based on the energy consumption models for the respective server configurations and the normalized unit of computing demand of the portion of the workload assigned to the respective server for a given allocation. The computer readable program code is configured to select a first of the allocations based on the predicted energy consumptions for the different allocations.

Embodiments of the present disclosure were described herein with reference to the accompanying drawings. Other embodiments may take many different forms and should not be construed as limited to the embodiments set forth herein. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the various embodiments described herein. As used herein, the term “and/or” includes any and all combinations of one or more of the associated listed items.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” when used herein, specify the presence of stated features, integers, steps, operations, elements, and/or components, but do not preclude the presence or addition of one or more other features, integers, steps, operations, elements, components, and/or groups thereof Elements described as being “to” perform functions, acts and/or operations may be configured to or other structured to do so.

Unless otherwise defined, all terms (including technical and scientific terms) used herein have the same meaning as commonly understood by one of ordinary skill in the art to which various embodiments described herein belong. It will be further understood that terms used herein should be interpreted as having a meaning that is consistent with their meaning in the context of this specification and the relevant art and will not be interpreted in an idealized or overly formal sense unless expressly so defined herein.

As will be appreciated by one of skill in the art, various embodiments described herein may be embodied as a method, data processing system, and/or computer program product. Furthermore, embodiments may take the form of a computer program product on a tangible computer readable storage medium having computer program code embodied in the medium that can be executed by a computer.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computer environment or offered as a service such as a Software as a Service (SaaS).

Some embodiments are described herein with reference to flowchart illustrations and/or block diagrams of methods, systems and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

In the drawings and specification, there have been disclosed typical embodiments and, although specific terms are employed, they are used in a generic and descriptive sense only and not for purposes of limitation, the scope of the disclosure being set forth in the following claims.

What is claimed is:

1. A method comprising:
creating an energy consumption model for each of a plurality of servers;
predicting different energy consumptions for executing a workload in corresponding different allocations of the workload to the plurality of servers, the predicting being based on the energy consumption models for the respective servers; and
selecting a first allocation of the workload to the plurality of servers based on the predicted energy consumptions.

2. The method of claim 1, wherein the predicting different energy consumptions for executing a workload in corresponding different allocations of the workload to the plurality of servers further comprises:
re-assigning a first portion of the workload to a different time; and
predicting, based on the energy consumption models, energy consumption for executing the workload with the first portion re-assigned to the different time.

3. The method of claim 1, wherein the predicting different energy consumptions for executing a workload in corresponding different allocations of the workload to the plurality of servers further comprises:
re-assigning a first portion of the workload to a different server; and
predicting, based on the energy consumption models, energy consumption for executing the workload with the first portion re-assigned to the different server.

4. The method of claim 1, wherein the predicting energy consumptions is further based on predicted environmental conditions in an environment of the plurality of servers.

5. The method of claim 1, further comprising characterizing respective portions of the workload in terms of a normalized unit of computing demand for the respective portion of the workload, wherein the creating an energy consumption model for a respective one of the plurality of servers comprises:
building a model of energy usage in terms of the normalized unit of computing demand.

6. The method of claim 5, wherein the predicting different energy consumptions for executing a workload in corresponding different allocations of the workload to the plurality of servers comprises:
a) predicting an amount of energy that the respective servers would take to process the respective portion of the workload assigned to the respective server given the computing demand of the respective portion of the workload and the amount of energy consumed by the respective server to perform the normalized unit of computing demand; and
b) repeating said a) for different allocations of the workload to the plurality of servers.

7. The method of claim 5, wherein the predicting different energy consumptions for executing a workload in corresponding different allocations of the workload to the plurality of servers comprises:
a) predicting an amount of energy that the respective servers would take to process the portion of the workload assigned to the respective server given the computing demand of the respective portion of the workload and the amount of energy consumed by the respective server to perform the normalized unit of computing demand; and
b) repeating said a) after shifting a first portion of the workload amongst the servers in time.

8. The method of claim 1, wherein each of the plurality of servers comprises a plurality of resources, the creating an energy consumption model for each of a plurality of servers comprises building each respective energy consumption model to forecast energy usage in terms of a normalized unit of computing demand for each of the plurality of resources of the server, the portions of the workload are characterized in terms of a normalized unit of computing demand for each of the plurality of resources.

9. The method of claim 1, wherein the selecting a first allocation of the workload to the plurality of servers based on the predicted energy consumptions comprising selecting an allocation that minimizes energy consumption.

10. A system comprising:
a processor configured to:
train a plurality of energy consumption models, each of the energy consumption models for a server, each energy consumption model forecasts energy usage in terms of a normalized unit of computing demand on the respective server;
predict different energy consumptions for executing the workload in corresponding different allocations to the servers based on the energy consumption models for the respective servers; and
select a first of the different allocations of the workload to the servers based on the predicted energy consumption for the different allocations.

11. The system of claim 10, wherein the processor being configured to predict different energy consumptions for executing the workload comprises the processor being configured to:
re-assign a first portion of the workload to a different time; and
predict, based on the energy consumption models, energy consumption for executing the workload with the first portion of the workload re-assigned to the different time.

12. The system of claim 10, wherein the processor being configured to predict different energy consumptions for executing the workload comprises the processor being configured to:
re-assign a first portion of the workload to a different server; and
predict, based on the energy consumption models, energy consumption for executing the workload with the first portion re-assigned to the different server.

13. The system of claim 10, wherein the processor being configured to predict different energy consumptions for executing the workload comprises the processor being configured to:
predict energy consumption for the workload based on predicted environmental conditions in an environment of the servers.

14. The system of claim 10, wherein the processor being configured to predict different energy consumptions for executing the workload comprises the processor being configured to build a model of energy usage in terms of the normalized unit of computing demand on each respective server.

15. The system of claim 14, wherein the processor being configured to predict different energy consumptions for executing the workload comprises the processor being configured to:
a) predict an amount of energy that each respective server would take to process the respective portion of the workload assigned to the respective server given computing demand of the respective portion and the amount of energy consumed by the respective server to perform the normalized unit of computing demand; and
b) repeat said a) for different allocations of workload to the servers.

16. The system of claim 14, wherein the processor being configured to predict different energy consumptions for executing the workload comprises the processor being configured to:
a) predict an amount of energy that each respective server would take to process the respective portion of the workload assigned to the respective server given computing demand of the respective portion and the amount of energy consumed by the respective server to perform the normalized unit of computing demand; and
b) repeat said a) after shifting a first portion of the workload to a different time.

17. The system of claim 10, wherein each of the servers comprises a plurality of resources, the processor being configured to train a plurality of energy consumption models comprises the processor being configured build each respective energy consumption model to forecast energy usage in terms of the normalized unit of computing demand for each of the plurality of resources of the server, the portions of the workload are characterized in terms of the normalized unit of computing demand for each of the plurality of resources.

18. A computer program product comprising:
a computer readable storage medium having computer readable program code embodied therewith, the computer readable program code comprising:
computer readable program code configured to create a plurality of energy consumption models, each of the energy consumption models being for a server configuration, each server configuration comprising a plurality of resources, the creating a plurality of energy consumption models comprises building each respective energy consumption model to forecast energy usage in terms of a normalized unit of computing demand for each of the plurality of resources of the respective server;
computer readable program code configured to access characteristics of a workload, the workload is characterized in terms of the normalized unit of computing demand for each of the plurality of resources;
computer readable program code configured to predict energy consumption for the workload in different allocations to a plurality of servers in a datacenter, each of the servers having one of the server configurations, the computer readable program code configured to predict energy consumption predicts based on the energy consumption models for the respective server configurations and the normalized unit of computing demand of a portion of the workload assigned to the respective server for a given allocation; and
computer readable program code configured to select a first of the allocations based on the predicted energy consumptions for the different allocations.

19. The computer program product of claim 18, wherein the computer readable program code configured to create a plurality of energy consumption models comprises computer readable program code configured to build each respective energy consumption model to forecast energy usage in terms of the normalized unit of computing demand for each of the plurality of resources of the server configuration and environmental conditions.

20. The computer program product of claim 19, wherein the computer readable program code configured to predict energy consumption for the workload comprises:
computer readable program code configured to re-assign a first portion of the workload to a different server to create a first allocation of the allocations; and
computer readable program code configured to re-assign a second portion of the workload to a different time to create a second allocation of the allocations.

21. The computer program product of claim 18, wherein the computer readable program code configured to select a first of the allocations based on the predicted energy consumptions for the different allocations comprises computer readable program code configured to determine which of the allocations minimizes energy consumption for executing the workload on the servers.

22. The computer program product of claim 18, wherein the computer readable program code configured to select a first of the allocations based on the predicted energy consumptions for the different allocations comprises computer readable program code configured to determine which of the allocations optimizes energy consumption for executing the workload on the servers.
